(19) United States
(12) Patent Application Publication
(10) Pub. No.: US 2026/0085956 A1
(43) Pub. Date: Mar. 26, 2026

(54) AIR FLOW METER

(71) Applicant: Hitachi Astemo, Ltd., Hitachinaka-shi, Ibaraki (JP)

(72) Inventors: Mizuki SHIBATA, Hitachinaka-shi, Ibaraki (JP); Takayuki YOGO, Hitachinaka-shi, Ibaraki (JP); Linlin ZHANG, Hitachinaka-shi, Ibaraki (JP)

(73) Assignee: Hitachi Astemo, Ltd., Hitachinaka-shi, Ibaraki (JP)

(21) Appl. No.: 18/703,575

(22) PCT Filed: Oct. 26, 2021
(86) PCT No.: PCT/JP2021/039381

§ 371 Date: May 12, 2025

(51) Int. Cl. G01F 1/684

(52) U.S. Cl. CPC G01F 1/684

(57) ABSTRACT

This air flow rate meter comprises an enclosure having an auxiliary passage and a circuit chamber, and a flow rate detection sensor. The flow rate detection sensor has a diaphragm in which a flow rate detection unit is formed on a main surface, a recessed section formed on the reverse-surface side of the diaphragm, and a package part having a first package section and a second package section, the first package section being positioned in the auxiliary passage, and the second package section being positioned in the circuit chamber. An airflow passage linked to the recessed section is formed in the interior of the package part. The recessed section communicates with the auxiliary passage via a plurality of ventilation pathways that communicate with the auxiliary passage via the airflow passage.

### TECHNICAL FIELD

The present invention relates to an air flow meter.

### BACKGROUND ART

A thermal air flow meter is known as one of air flow meters that measure an air flow rate. The thermal air flow meter is a device that measures an air flow rate by performing heat transfer with air to be measured. The thermal air flow meter is used for measuring a flow rate of air sucked into an internal combustion engine of an automobile or the like.

In recent years, attention has been given to a thermal air flow meter including a package in which a diaphragm is formed on a semiconductor chip by micromachining technology, a resistor is provided on the diaphragm, and the semiconductor chip is sealed with a resin (for example, Patent Literature 1).

In the thermal air flow meter described in Patent Literature 1, a resistor is formed on a main surface of a diaphragm, and a recessed section (gap) is formed on a reverse-surface side of the diaphragm located on a side opposite to the main surface. In such a configuration, when there is a difference between the pressure on the main surface side and the pressure on the reverse-surface side of the diaphragm, the diaphragm may be deformed due to this pressure difference, and there is a possibility that accuracy in measuring the air flow rate decreases.

Therefore, in the thermal air flow meter described in Patent Literature 1, an airflow passage connected to the recessed section on the diaphragm reverse-surface side is formed in the package, and the airflow passage is communicated with an auxiliary passage in which the diaphragm is disposed. In the thermal air flow meter described in Patent Literature 1, a slit is formed in the middle of a ventilation pathway from the airflow passage to the auxiliary passage so that foreign matter such as dust, contaminants, and water that has entered from a main passage to the auxiliary passage does not enter a circuit chamber.

### CITATION LIST

### Patent Literature

Patent Literature 1: JP 2014-71032 A

### SUMMARY OF INVENTION

### Technical Problem

However, after careful studies have been conducted by the present inventors, it has been found that even when the configuration of the thermal air flow meter described in Patent Literature 1 is adopted, deformation occurs in the diaphragm under specific circumstances. Specifically, it has been found that, in a high flow rate region where a predetermined amount or more of air flows through the auxiliary passage, the auxiliary passage has a negative pressure, a pressure difference is generated between the space in the auxiliary passage and the space in the circuit chamber, and the diaphragm may be deformed.

An object of the present invention is to provide an air flow meter capable of effectively suppressing deformation of a diaphragm and improving accuracy in measuring an air flow rate.

### Solution to Problem

In order to solve the above problem, for example, a configuration described in the claims is adopted.

The present application includes a plurality of means for solving the above described problems, and one of them is an air flow meter including: an enclosure including an auxiliary passage through which air to be measured flows and a circuit chamber partitioned from the auxiliary passage; a flow rate detection sensor including a diaphragm having a main surface on which a flow rate detection unit that detects a flow rate of the air flowing through the auxiliary passage is formed, a recessed section formed on a reverse-surface side of the diaphragm, and a package part having a first package section arranged in a state where the diaphragm is exposed and a second package section having an integrated structure with the first package section, in which the first package section is arranged in the auxiliary passage, and the second package section is arranged in the circuit chamber. An airflow passage connected to the recessed section is formed in the interior of the package part, and the recessed section communicates with the auxiliary passage via a plurality of ventilation pathways including at least a first ventilation pathway communicating with the auxiliary passage via the airflow passage and a second ventilation pathway communicating with the auxiliary passage through a pathway different from the first ventilation pathway via the airflow passage.

### Advantageous Effects of Invention

According to the present invention, deformation of the diaphragm can be effectively suppressed, and accuracy in measuring the air flow rate can be improved.

Problems, configurations, and effects other than those described above will be clarified by the following description of embodiments.

### BRIEF DESCRIPTION OF DRAWINGS

FIG. 1 is a view illustrating a configuration example of an internal combustion engine control system including an air flow meter according to the present embodiment.

FIG. 2 is a front view of the air flow meter according to the present embodiment.

FIG. 3 is a view illustrating a state where the air flow meter illustrated in FIG. 2 with a cover removed.

FIG. 4 is a view in which a protective layer and a sealing layer are made transparent in the air flow meter illustrated in FIG. 3.

FIG. 5 is a cross-sectional view illustrating an arrangement state of a flow rate detection sensor in the air flow meter according to the present embodiment.

FIG. 6 is a top view of the flow rate detection sensor.

FIG. 7 is a bottom view of the flow rate detection sensor.

FIG. 8 is a perspective view of the flow rate detection sensor as viewed from the top surface side.

FIG. 9 is a perspective view of the flow rate detection sensor as viewed from the bottom side.

FIG. 10 is a perspective view including a cross section taken at A-A position in FIG. 8.

FIG. 11 is a perspective view including a cross section taken at B-B position in FIG. 8.

FIG. 12 is a view of a lead frame as viewed from the top surface side.

FIG. 13 is an enlarged view of a portion C in FIG. 8.

FIG. 14 is an enlarged view of a portion D in FIG. 10.

### DESCRIPTION OF EMBODIMENTS

Hereinafter, embodiments of the present invention will be described in detail with reference to the drawings. In the present specification and the drawings, elements having substantially the same function or configuration are denoted by the same reference numerals, and redundant description is omitted.

### (Configuration of Internal Combustion Engine Control System)

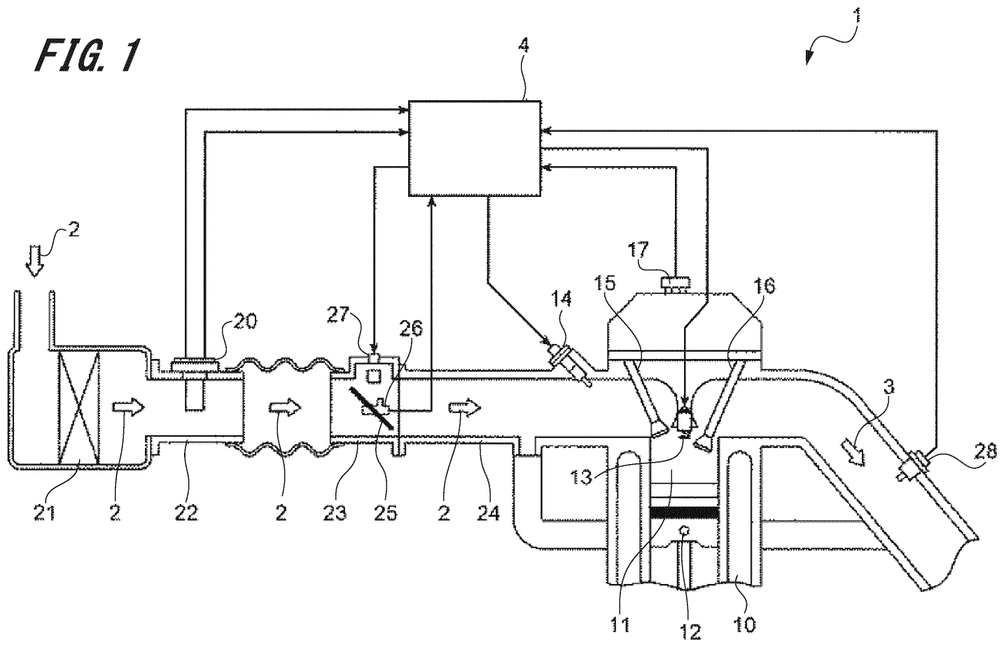

FIG. 1 is a view illustrating a configuration example of an internal combustion engine control system including an air flow meter according to the present embodiment.

In an internal combustion engine control system 1 illustrated in FIG. 1, air 2 is guided to a combustion chamber of an engine cylinder 11 through an air cleaner 21, a main passage 22, a throttle body 23, and an intake manifold 24 based on an operation of an internal combustion engine 10 including the engine cylinder 11 and an engine piston 12. The main passage 22 is formed by an intake body. The air flow meter 20 is disposed in the middle of the main passage 22. The air flow meter 20 is a device that measures the flow rate of the air 2 flowing through the main passage 22. In the present embodiment, a case where the air flow meter 20 is a thermal air flow meter will be described as an example.

A fuel injection valve 14 injects a predetermined amount of fuel based on the air flow rate measured by the air flow meter 20. As a result, in a state of being mixed with each other, the fuel and the air are guided to the combustion chamber through an intake valve 15. The mixed gas of the fuel and the air guided to the combustion chamber is explosively burned by spark ignition of an ignition plug 13 to generate mechanical energy. The gas after combustion is guided to an exhaust pipe through an exhaust valve 16 and is discharged from the exhaust pipe to the outside of a vehicle as an exhaust gas 3.

The flow rate of the air guided to the combustion chamber is controlled by a throttle valve 25. The opening degree of the throttle valve 25 changes according to an operation of an accelerator pedal (not illustrated). A throttle angle sensor 26 measures the opening degree of the throttle valve 25. A rotation angle sensor 17 is a sensor for measuring positions and states of the engine piston 12, the intake valve 15, and the exhaust valve 16, and for measuring the rotation speed of the internal combustion engine 10. An oxygen sensor 28 is a sensor for measuring the state of the mixture ratio between the amount of fuel and the amount of air based on the state of the exhaust gas 3.

The control device 4 controls the amount of fuel injection by the fuel injection valve 14 and the timing of ignition by the ignition plug 13 based on the measurement results of the air flow meter 20 and the rotation angle sensor 17. In addition, the control device 4 controls the amount of air bypassing the throttle valve 25 by an idle air control valve 27 in the idle operation state of the internal combustion engine 10.

### (Configuration of Air Flow Meter)

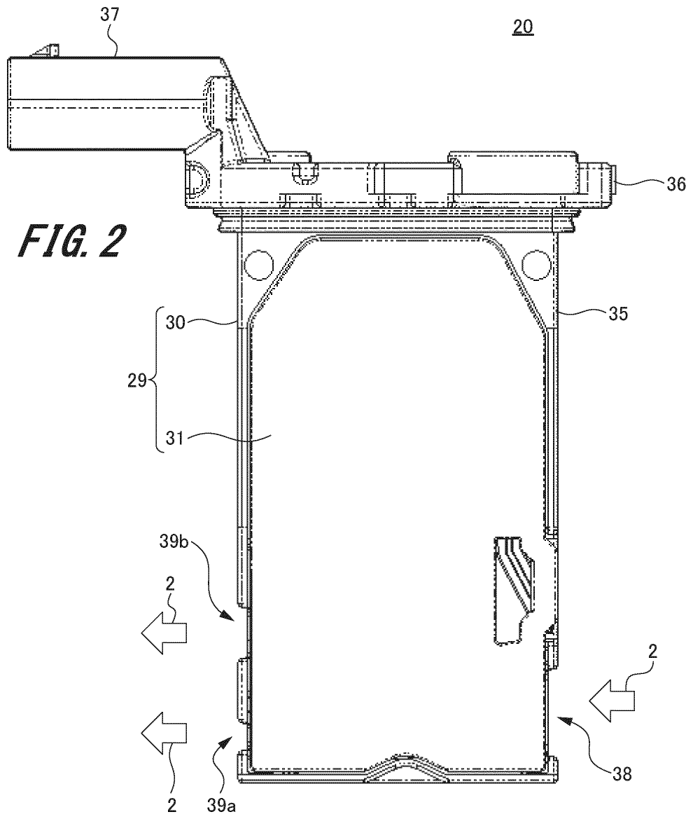

FIG. 2 is a front view of the air flow meter according to the present embodiment. In the present embodiment, the vertical direction and the horizontal direction of the air flow meter 20 are defined assuming that the air flow meter 20 is attached to the main passage 22 in the direction shown in FIG. 2 and the air 2 flows in the main passage 22 in the direction of the arrow.

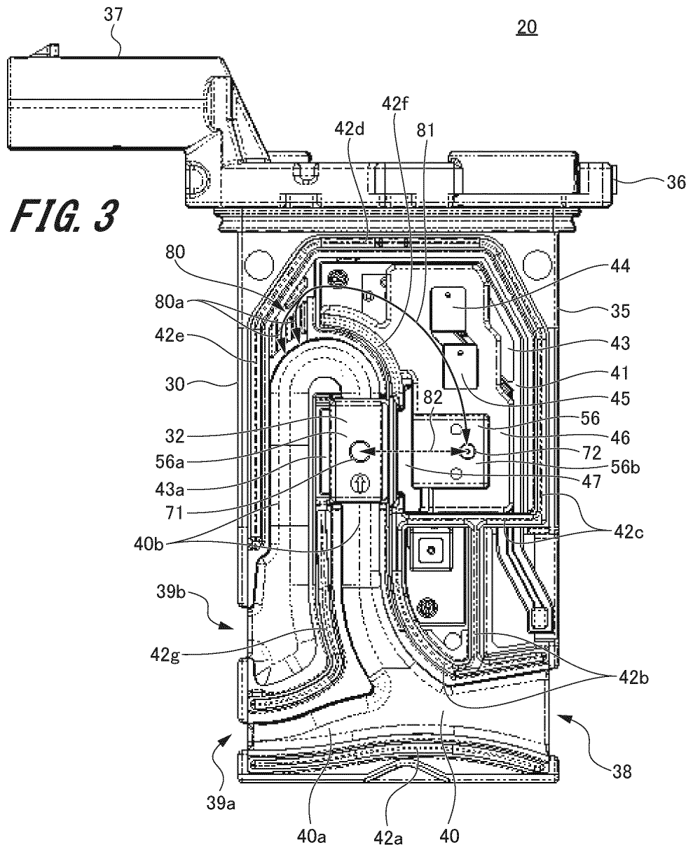

As illustrated in FIG. 2, the air flow meter 20 includes a housing 30, a cover 31 attached to the housing 30, and a flow rate detection sensor 32 (see FIG. 3) accommodated in a space formed by the housing 30 and the cover 31. An enclosure 29 of the air flow meter 20 includes the housing 30 and the cover 31. The housing 30 includes a housing main body 35 having a rectangular shape in a front view, a flange 36 formed on an upper end side of the housing main body 35, and a connector 37 protruding from the flange 36.

The cover 31 is attached to the housing main body 35 of the housing 30. The enclosure 29 including the housing 30 and the cover 31 has one air inlet 38 and three air outlets 39a and 39b. The flange 36 is a portion for fixing the air flow meter 20 to the intake body forming the main passage 22. The connector 37 is a portion for electrically connecting the air flow meter 20 to the control device 4.

FIG. 3 is a view illustrating the air flow meter 20 illustrated in FIG. 2 with the cover 31 removed.

As illustrated in FIG. 3, the housing main body 35 includes an auxiliary passage 40 through which air to be measured flows, and a circuit chamber 41 partitioned off from the auxiliary passage 40. The auxiliary passage 40 is a passage connecting one air inlet 38 and two air outlets 39a and 39b described above. The auxiliary passage 40 includes a first auxiliary passage 40a and a second auxiliary passage 40b. The auxiliary passage 40 is divided into the first auxiliary passage 40a and the second auxiliary passage 40b in the middle thereof.

On the other hand, the air outlet 39a opens at the terminal of the first auxiliary passage 40a, and the air outlet 39b opens at the terminal of the second auxiliary passage 40b. The second auxiliary passage 40b is bent in a U shape. By forming the auxiliary passage 40 inside the enclosure 29 in this manner, a part of the air 2 flowing through the main passage 22 illustrated in FIG. 1 is introduced into the auxiliary passage 40 from the air inlet 38. Also, the air introduced from the air inlet 38 flows along the auxiliary passage 40, and the flow of the air is divided into the first auxiliary passage 40a and the second auxiliary passage 40b in the middle of the auxiliary passage 40. Furthermore, the air flowing along the first auxiliary passage 40a is derived from the air outlet 39a to the main passage 22, and the air flowing along the second auxiliary passage 40b is derived from the air outlet 39b to the main passage 22.

A plurality of recessed grooves 42a to 42g are formed in the housing main body 35. The plurality of recessed grooves 42a to 42g are formed so as to surround the auxiliary passage 40 and the circuit chamber 41. On the other hand, a plurality of protrusions (not illustrated) is formed in the cover 31 so as to correspond to the plurality of recessed grooves 42a to 42g. The plurality of recessed grooves 42a to 42g and the plurality of protrusions are fitted to each other when the cover 31 is attached to the housing main body 35. Then, the fitting portion is sealed in an airtight state by a sealing material such as a silicone resin.

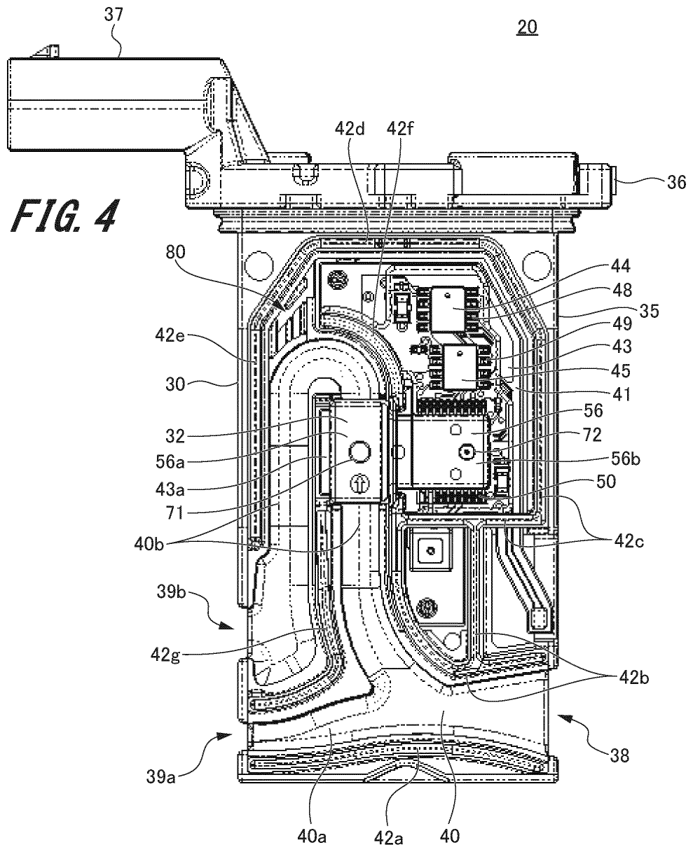

The circuit chamber 41 is formed adjacent to the second auxiliary passage 40b. A circuit board 43 is attached to the circuit chamber 41. A part 43a of the circuit board 43 is disposed in a state of protruding from the circuit chamber 41 to the second auxiliary passage 40b. The flow rate detection sensor 32 and two pressure sensors 44 and 45 are mounted on the circuit board 43. The flow rate detection sensor 32 and the respective pressure sensors 44 and 45 are both constituted by a semiconductor package. A protective layer 46 is formed on the circuit board 43, and a sealing layer 47 is formed on the semiconductor package constituting the flow rate detection sensor 32. FIG. 4 is a view in which the protective layer 46 and the sealing layer 47 are made transparent in the air flow meter 20 illustrated in FIG. 3. As can be seen from FIG. 4, the flow rate detection sensor 32 has a plurality of lead terminals 50. Further, the pressure sensor 44 includes a plurality of lead terminals 48, and the pressure sensor 45 also includes a plurality of lead terminals 49. The flow rate detection sensor 32 and each of the pressure sensors 44 and 45 are constituted by a small outline package (SOP) which is one form of a semiconductor package.

Further, the flow rate detection sensor 32 and each of the pressure sensors 44 and 45 are both mounted on the circuit board 43 by soldering. Specifically, the plurality of lead terminals 50 included in the flow rate detection sensor 32 are soldered to a plurality of electrode portions (not illustrated) formed on the circuit board 43 corresponding to the mounting position of the flow rate detection sensor 32. Similarly, the plurality of lead terminals 48 included in the pressure sensor 44 are soldered to the plurality of electrode portions (not illustrated) formed on the circuit board 43, and the plurality of lead terminals 49 included in the pressure sensor 45 are soldered to the plurality of electrode portions (not illustrated) formed on the circuit board 43.

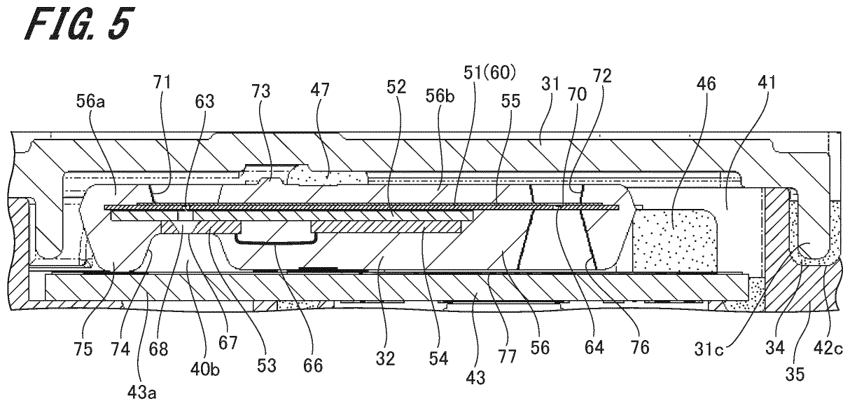

The protective layer 46 is a layer for protecting the lead terminal 48 of the pressure sensor 44, the lead terminal 49 of the pressure sensor 45, and the lead terminal 50 of the flow rate detection sensor 32. The protective layer 46 is formed of, for example, a silicone resin. As illustrated in FIG. 5, the sealing layer 47 is a layer for filling and sealing a gap formed between the semiconductor package and the cover 31 when the cover 31 is attached to the housing main body 35. The sealing layer 47 is formed of, for example, a silicone resin. Note that FIG. 5 illustrates a structure in which the protrusions 31c of the cover 31 are fitted into the recessed groove 42c of the housing main body 35 and this fitting portion is sealed with a sealing material 34 such as silicone resin, but a similar sealing structure is also applied to the fitting portion between the groove and the protrusion (not illustrated).

### (Configuration of Flow Rate Detection Sensor)

Next, a configuration of the flow rate detection sensor 32 will be described in detail. In addition, in the description of the configuration of the flow rate detection sensor 32, in FIG. 5, a side facing the cover 31 is a top surface side of the flow rate detection sensor 32, and a side facing the circuit board 43 is a bottom surface side of the flow rate detection sensor 32.

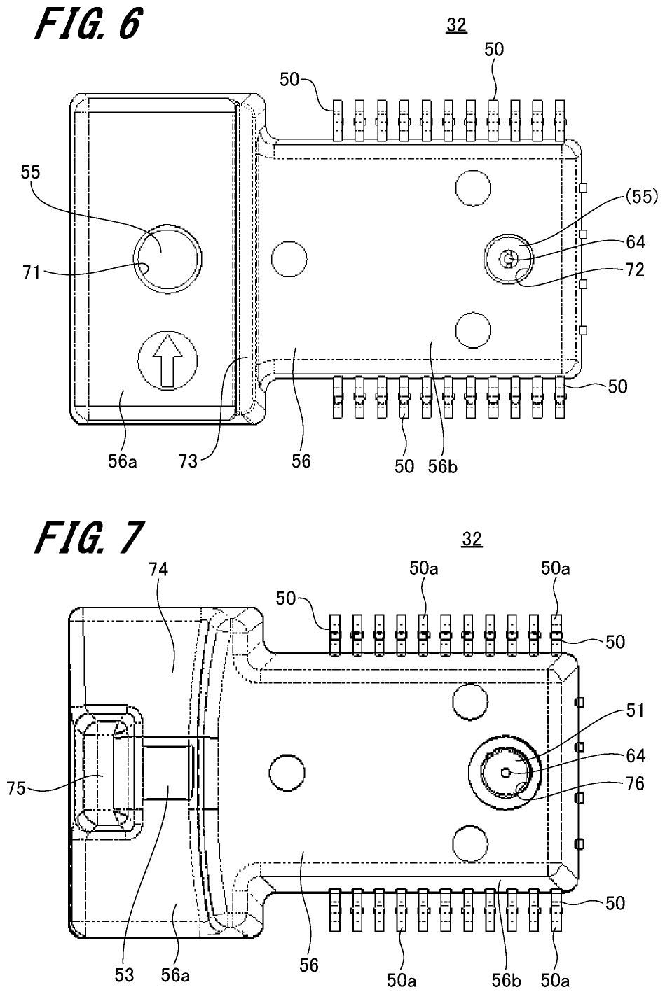

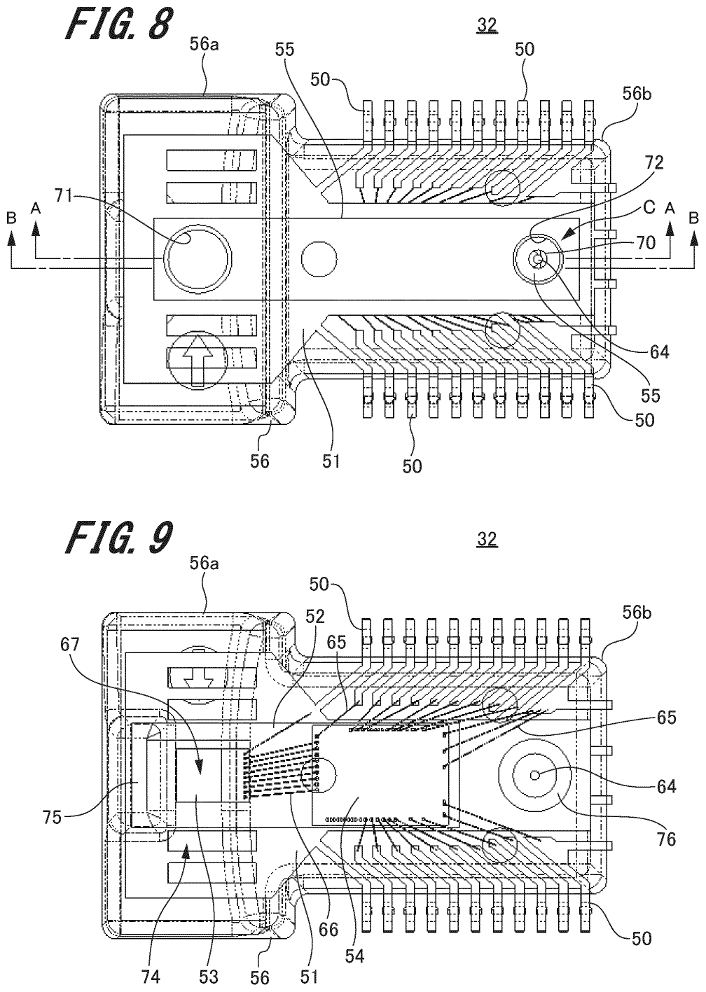

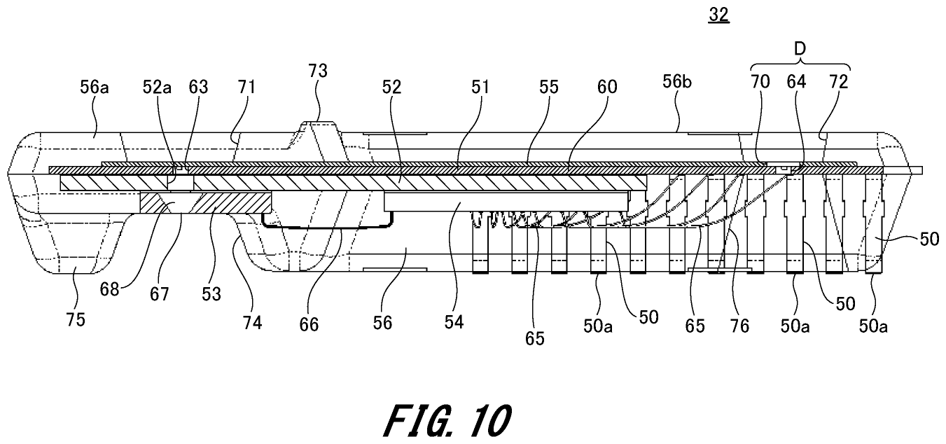

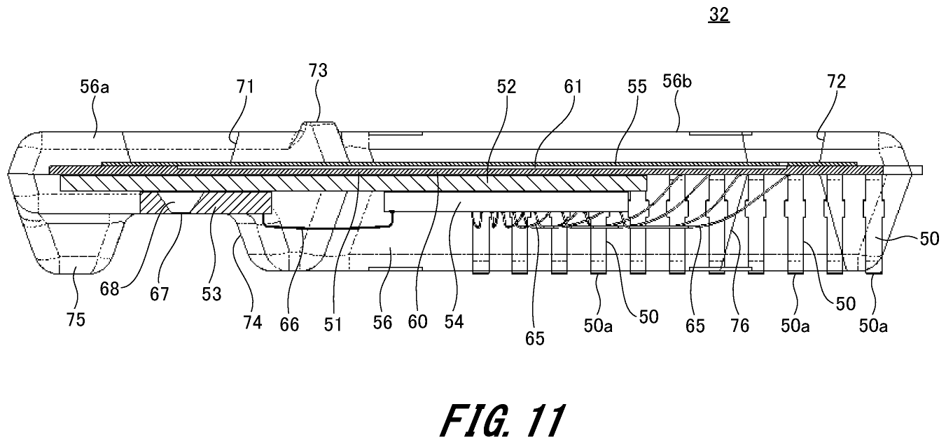

FIG. 6 is a top view of the flow rate detection sensor 32, and FIG. 7 is a bottom view of the flow rate detection sensor 32. FIG. 8 is a perspective view of the flow rate detection sensor 32 from the top surface side, and FIG. 9 is a perspective view of the flow rate detection sensor 32 from the bottom surface side. FIG. 10 is a perspective view including a cross section taken at A-A position in FIG. 8, and FIG. 11 is a perspective view including a cross section taken at B-B position in FIG. 8.

As illustrated in FIGS. 6 to 11, the flow rate detection sensor 32 includes a lead frame 51, a plate 52 attached to the lead frame 51, a flow rate detection element 53 mounted on the bottom surface of the plate 52, an LSI element 54 mounted on the bottom surface of the plate 52 together with the flow rate detection element 53, a resin sheet 55 attached to the top surface of the lead frame 51, and a package part 56 for resin-sealing the lead frame 51, the LSI element 54, and the like. The flow rate detection element 53 and the LSI element 54 are semiconductor chips constituted based on a semiconductor substrate such as silicon. The LSI is an abbreviation of large scale integration (LSI).

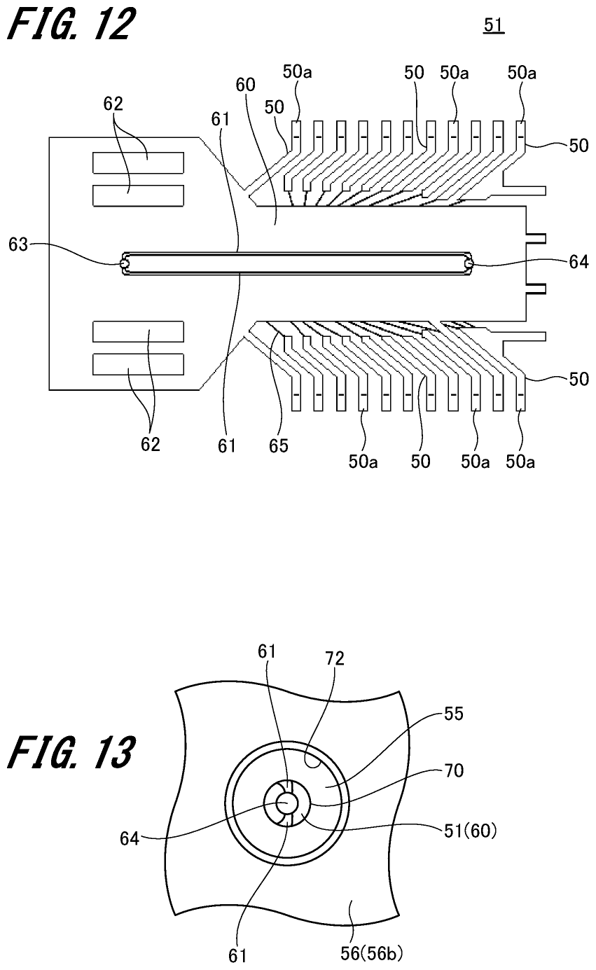

FIG. 12 is the view of a lead frame 51 as viewed from the top surface side.

As illustrated in FIG. 12, the lead frame 51 includes a plate-like portion 60 in addition to the plurality of lead terminals 50 described above. Each of the lead terminal 50 is bent into a gull wing shape. The bottom surface of the plate-like portion 60 is attached to the top surface of the plate 52 described above. The plate 52 is a member for alleviating stress due to a difference in linear expansion coefficient between the lead frame 51, the flow rate detection element 53, and the LSI element 54. A through hole 52a (see FIG. 10) is formed in the plate 52. The through hole 52a communicates with a through hole 63 of the lead frame 51 and a recessed section 68 of the flow rate detection element 53. Communication is a term meaning spatially connected. The plate 52 may be provided as necessary. Among the plurality of lead terminals 50, some of the lead terminals 50 are connected to the plate-like portion 60, and the other lead terminals 50 are electrically connected to the LSI element 54 via a bonding wire 65. The flow rate detection element 53 and the LSI element 54 are electrically connected via a bonding wire 66 (see FIG. 10). The bonding wires 65 and 66 are made of, for example, a gold wire.

Two grooves 61 are formed on the top surface of the plate-like portion 60. In addition, four through holes 62 and two through holes 63 and 64 are formed in the plate-like portion 60. The two grooves 61 correspond to airflow passages connected to the recessed section 68 and are formed in parallel to each other. In addition, the two grooves 61 are formed to be elongated along the longitudinal direction (right-left direction in FIG. 12) of the plate-like portion 60. One end portion in the length direction of each groove 61 is bent in an arc shape and connected to the through hole 63, and the other end portion in the length direction of each groove 61 is bent in an arc shape and connected to the through hole 64. Both of the through holes 63 and 64 are formed in a circular shape. The size of the through hole 64 is preferably set to a diameter of 0.3 mm or less so that foreign matter does not enter the groove 61 through the through hole 64. Note that the shape of the through holes 63 and 64 is not limited to a circular shape and may be any shape such as a polygonal shape.

As illustrated in FIGS. 10 and 11, the flow rate detection element 53 includes a diaphragm 67. The diaphragm 67 is formed by leaving a part of a semiconductor substrate serving as a base of the flow rate detection element 53 thin. In the present embodiment, the bottom surface of the diaphragm 67 corresponds to the main surface of the diaphragm 67, and the top surface of the diaphragm 67 corresponds to the back surface of the diaphragm 67. A flow rate detection unit (not illustrated) is formed on the bottom surface of the diaphragm 67. The flow rate detection unit is a portion that detects the flow rate of the air flowing through the second auxiliary passage 40b of the auxiliary passage 40. The flow rate detection unit includes, for example, a heating resistor and a pair of resistance temperature detectors. The recessed section 68 is formed on the top surface side of the diaphragm 67. The recessed section 68 forms a recessed space. The recessed section 68 is open on the side opposite to the diaphragm 67 with an area larger than that of the diaphragm 67.

The flow rate detection element 53 is fixed to the plate 52 with an adhesive (not illustrated), and the LSI element 54 is also fixed to the plate 52 with an adhesive (not illustrated). The LSI element 54 controls the amount of heat generated by the resistor in the flow rate detection unit of the flow rate detection element 53 and outputs a signal representing the air flow rate detected by the flow rate detection unit to the outside via the lead terminal 50.

The resin sheet 55 is attached to the top surface of the lead frame 51. The resin sheet 55 is a rectangular sheet elongated in the longitudinal direction of the flow rate detection sensor 32, and is formed of, for example, a polyimide tape. The resin sheet 55 is attached to the lead frame 51 so as to cover the groove 61 and the through hole 63 of the lead frame 51. A circular through hole 70 (see FIGS. 8 and 10) is formed in the resin sheet 55.

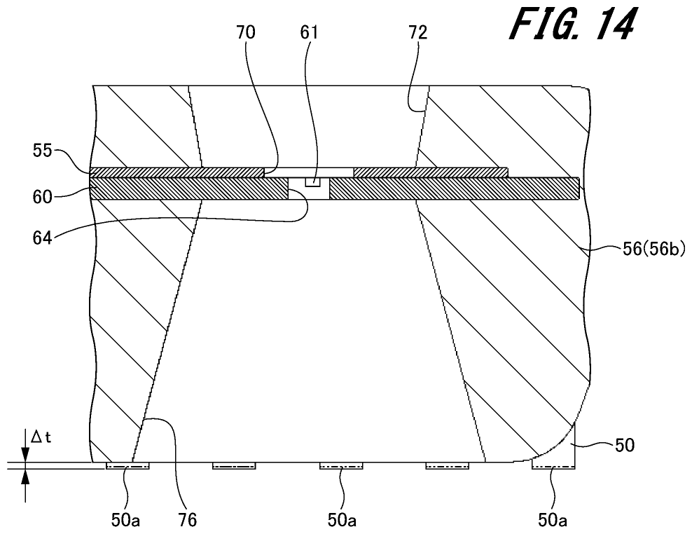

FIG. 13 is an enlarged view of a portion C in FIG. 8.

As shown in FIG. 13, the through hole 70 of the resin sheet 55 is opened with a larger dimension than the through hole 64 of the lead frame 51. The through hole 64 and the through hole 70 are concentrically disposed.

The package part 56 is obtained, for example, by forming a thermosetting resin into a predetermined shape by molding. As illustrated in FIGS. 6 and 7, the package part 56 includes a first package section 56a and a second package section 56b integrated with the first package section 56a. The first package section 56a mainly seals the flow rate detection element 53 side with resin, and the second package section 56b mainly seals the LSI element 54 side with resin. In the air flow meter 20, the first package section 56a is disposed in the second auxiliary passage 40b of the auxiliary passage 40, and the second package section 56b is disposed in the circuit chamber 41 (see FIGS. 3 and 5).

The first package section 56a is formed to be wider than the second package section 56b. The plurality of lead terminals 50 described above are disposed on two sides of the second package section 56b. A first opening 71 is formed in the top surface of the first package section 56a, and a second opening 72 is formed in the top surface of the second package section 56b. The first opening 71 is formed in a circular shape in plan view, and the second opening 72 is also formed in a circular shape in plan view. In addition, the first opening 71 is formed in a trapezoidal cross section so as to gradually increase in diameter toward the top surface of the first package section 56a, and the second opening 72 is formed in a trapezoidal cross section so as to gradually increase in diameter toward the bottom surface of the second package section 56b. As illustrated in FIG. 13, the second opening 72 is opened with a larger dimension than the through hole 70 of the resin sheet 55. Further, the second opening 72 is disposed concentrically with the through hole 64 and the through hole 70. Furthermore, a bank section 73 (see FIGS. 5 and 6) is formed on the top surface of the package part 56. The bank section 73 is formed near the boundary between the first package section 56a and the second package section 56b. The above described sealing layer 47 (FIG. 3) is disposed closer to the second package section 56b side than the bank section 73.

On the other hand, an airflow part 74 is formed on the bottom surface side of the package part 56 as illustrated in FIGS. 10 and 11. The airflow part 74 is a part for passing air flowing through the second auxiliary passage 40b of the auxiliary passage 40. The airflow part 74 is formed in a concave shape by reducing the thickness dimension of the first package section 56a except for a convex part 75 provided on the bottom surface of the first package section 56a. The bottom surface of the diaphragm 67 described above is disposed in a state of being exposed to the recessed space of the airflow part 74. That is, in the first package section 56a, the diaphragm 67 is disposed in a state of being exposed to the recessed space of the airflow part 74. A third opening 76 is formed on the bottom surface of the second package section 56b. The third opening 76 is formed in a trapezoidal cross section so as to gradually increase in diameter toward the bottom surface of the second package section 56b. As illustrated in FIG. 9, the third opening 76 is disposed concentrically with the through hole 64 of the lead frame 51.

FIG. 14 is an enlarged view of a portion D in FIG. 10.

As illustrated in FIG. 14, a terminal portion 50a of the lead terminal 50 is arranged to protrude downward by a slight amount Δt from the bottom surface of the package part 56. The terminal portion 50a of the lead terminal 50 is a portion soldered to the electrode portion of the circuit board 43. Therefore, as illustrated in FIG. 5, in a state where the flow rate detection sensor 32 is mounted on the circuit board 43, the package part 56 slightly floats from the circuit board 43. Therefore, a minute gap 77 corresponding to the protrusion amount Δt is formed between the circuit board 43 and the package part 56. The gap 77 is a ventilation gap that allows the third opening 76 and the second auxiliary passage 40b to communicate with each other. In the circuit chamber 41, the periphery of the second package section 56b is sealed by the protective layer 46 and the sealing layer 47, and the gap 77 is formed in the sealed region. The dimension of the gap 77 in the thickness direction of the package part 56 may be set to such a dimension that foreign matter flowing in the auxiliary passage 40 together with air can be suppressed from entering the third opening 76 through the gap 77. The foreign matter is, for example, water, dust, or the like.

In the flow rate detection sensor 32 configured as described above, the two grooves 61 are formed as airflow passages inside the package part 56. One end of the groove 61 is connected to the recessed section 68 via the through hole 52a of the plate 52. That is, one end portion of the groove 61 communicates with the recessed section 68 via the through hole 52a. On the other hand, the other end portion of the groove 61 is connected to the through hole 64 as a branch portion. That is, the other end portion of the groove 61 communicates with the through hole 64. The branch portion is a portion where a first ventilation pathway 81 and a second ventilation pathway 82 illustrated in FIG. 3 branch from each other, and this branch portion is formed by the through hole 64. As illustrated in FIGS. 8 and 9, the through hole 64 is open to both the second opening 72 and the third opening 76. The second opening 72 forms a part of first ventilation pathway 81, and third opening 76 forms a part of second ventilation pathway 82.

The first ventilation pathway 81 and the second ventilation pathway 82 are formed using the two grooves 61 formed in the lead frame 51 as airflow passages. The first ventilation pathway 81 and second ventilation pathway 82 branch into one and the other from through hole 64 formed in lead frame 51 as a branch portion. That is, first ventilation pathway 81 and second ventilation pathway 82 are different pathways from each other. Specifically, the first ventilation pathway 81 communicates with the circuit chamber 41 from the through hole 64 through the second opening 72, and further communicates with the second auxiliary passage 40b from the circuit chamber 41 through the ventilation part 80 (see FIGS. 3 and 4). The pressure sensors 44 and 45 are disposed in the middle of the first ventilation pathway 81. On the other hand, the second ventilation pathway 82 communicates with the gap 77 from the through hole 64 through the third opening 76 and communicates with the second auxiliary passage 40b through the gap 77.

### (Ventilation Part)

The ventilation part 80 is a part that ventilates the second auxiliary passage 40b and the circuit chamber 41 at a position away from the second package section 56b. As illustrated in FIG. 3, the ventilation part 80 is formed so as to communicate with the second auxiliary passage 40b and the circuit chamber 41 at a bent portion (folded portion) of the second auxiliary passage 40b. The ventilation part 80 includes an introduction passage including a plurality of ventilation portions 80a. As for the introduction passage, preferably, the same configuration as the “pressure introduction passage” described in JP 2021-67510 A may be adopted. However, as the configuration of the introduction passage, a configuration different from the “pressure introduction passage” described in the above described Public Patent Publication may be adopted.

As described above, in the air flow meter 20 according to the present embodiment, the airflow passage is formed by the two grooves 61 inside the package part 56, and the first ventilation pathway 81 and the second ventilation pathway 82 communicating with the auxiliary passage 40 (second auxiliary passage 40b) through the airflow passage are provided. Further, the first ventilation pathway 81 and second ventilation pathway 82 are formed as follows.

The first ventilation pathway 81 is formed to pass through the through hole 52a formed in the plate 52, the groove 61 having one end connected to the through hole 52a, the through hole 64 connected to the other end of the groove 61, the second opening 72 for exposing the through hole 64, the circuit chamber 41, and the ventilation part 80 for communicating the circuit chamber 41 with the second auxiliary passage 40b.

The second ventilation pathway 82 is formed so as to pass through the through hole 52a formed in the plate 52, the groove 61 having one end connected to the through hole 52a, the through hole 64 connected to the other end of the groove 61, the third opening 76 for exposing the through hole 64, and the gap 77 communicating with third opening 76.

As a result, the recessed section 68 on the back surface side of the diaphragm 67 communicates with the auxiliary passage 40 (second auxiliary passage 40b) via the two ventilation pathways 81 and 82 using the groove 61 as an airflow passage.

Therefore, according to the air flow meter 20 of the present embodiment, as compared with a case where only one ventilation pathway connecting the recessed section 68 and the auxiliary passage 40 is formed as described in Patent Literature 1, ventilation performance (ventilation efficiency) between the recessed section 68 and the auxiliary passage 40 can be enhanced. Therefore, for example, even when a predetermined amount or more of air flows through the auxiliary passage 40 and the auxiliary passage 40 has a negative pressure, the pressure in the space in the recessed section 68 can be quickly brought close to the pressure in the space in the auxiliary passage 40. As a result, the pressure in the space can be uniformly maintained on the main surface side and the back surface side of the diaphragm 67, and deformation of the diaphragm 67 can be effectively suppressed. Therefore, the characteristic fluctuation of the flow rate detection sensor 32 due to the deformation of the diaphragm 67 can be suppressed, and accuracy in measuring the air flow rate can be improved. In addition, in the technique described in Patent Literature 1, the structure of the pressure introduction passage is devised to prevent foreign matter from entering the circuit chamber 41 from the auxiliary passage 40 (second auxiliary passage 40b). For this reason, for example, when the cross-sectional area of the introduction port of the ventilation introduction passage is secured to be large in order to improve the ventilation performance between the recessed section 68 and the auxiliary passage 40, foreign matter easily enters the circuit chamber 41 from the auxiliary passage 40. In this regard, in the air flow meter 20 according to the present embodiment, since the recessed section 68 and the auxiliary passage 40 are connected by the two ventilation pathways 81 and 82, the ventilation performance can be improved without increasing the cross-sectional area of the introduction port in the ventilation part 80. Therefore, it is possible to suppress foreign matters from entering the circuit chamber 41 from the auxiliary passage 40.

Also, in the present embodiment, one end portion of the groove 61 forming the airflow passage is connected to the recessed section 68, and the other end portion of the groove 61 is connected to the through hole 64 as a branch portion. Accordingly, while suppressing foreign matters entering the recessed section 68 by groove 61, the first ventilation pathway 81 and the second ventilation pathway 82 can branch at a position close to the recessed section 68. Therefore, even when pressure fluctuation occurs in the space in the auxiliary passage 40, the pressure in the space in the recessed section 68 can be quickly changed according to the pressure fluctuation. Therefore, it is possible to effectively suppress deformation of the diaphragm 67.

In addition, in the present embodiment, by forming the branch portion by the through hole 64, the circuit chamber 41 in which the second package section 56b is disposed and the third opening 76 provided in the second package section 56b communicate with each other via the through hole 64. For this reason, the air resistance of the entire ventilation pathways can be reduced as compared with the case where the first ventilation pathway 81 and the second ventilation pathway 82 are divided by the non-through hole (not illustrated). In addition, the space in the circuit chamber 41 and the space in the third opening 76 can be maintained at equal pressure. Therefore, the pressure difference between the recessed section 68 and the auxiliary passage 40 can effectively be suppressed by the interaction between the first ventilation pathway 81 and the second ventilation pathway 82.

In the present embodiment, since the first ventilation pathway 81 and the second ventilation pathway 82 are provided, ventilation performance between the auxiliary passage 40 and the circuit chamber 41 is improved; therefore, accuracy and responsiveness of the pressure sensors 44 and 45 can be improved by disposing the pressure sensors 44 and 45 in the middle of the first ventilation pathway 81.

In addition, in the present embodiment, the first ventilation pathway 81 includes the ventilation part 80 that ventilates the auxiliary passage 40 and the circuit chamber 41 at a position away from the second package section 56b, and the second ventilation pathway 82 includes the ventilation gap 77 formed between the package part 56 and the circuit board 43. Accordingly, the length of the second ventilation pathway 82 becomes shorter than the length of the first ventilation pathway 81. Therefore, by forming the second ventilation pathway 82 in addition to the first ventilation pathway 81, the pressure of the recessed section 68 can quickly follow the pressure fluctuation on the main surface side of the diaphragm 67. Further, the ventilation gap 77 is formed to be wide in the depth direction in FIG. 5, and the second ventilation pathway 82 communicates with the second auxiliary passage 40b and the third opening 76 through the gap 77. Therefore, the second auxiliary passage 40b and the third opening 76 can be maintained at equal pressure.

### <Modifications and the Like>

Note that the present invention is not limited to the above described embodiments and includes various modifications. For example, in the above described embodiments, the contents of the present invention are described in detail for easy understanding, but the present invention is not necessarily limited to one including all the configurations described in the above described embodiments. Further, a part of the configuration of one embodiment can be replaced with the configuration of another embodiment. Furthermore, the configuration of another embodiment can be added to the configuration of one embodiment. In addition, a part of the configuration of each embodiment can be deleted, another configuration can be added, or another configuration can be substituted.

For example, in the above described embodiment, the air flow meter 20 includes the two ventilation pathways 81 and 82, but the present invention is not limited thereto, and the air flow meter 20 may include three or more ventilation pathways. In addition, one of the plurality of ventilation pathways may be formed so as to pass through a groove, for example, by forming the groove for ventilation in the sealing layer 47.

In the above described embodiment, the airflow passage is formed by the two grooves 61, but the number of the grooves 61 may be one or three or more.

### REFERENCE SIGNS LIST

20 air flow meter

32 flow rate detection sensor

40 auxiliary passage

41 circuit chamber

29 enclosure

43 circuit board

44, 45 pressure sensor

56 package part

56a first package section

56b second package section

61 groove (airflow passage)

64 through hole (branch portion)

67 diaphragm

68 recessed section

77 gap

80 ventilation part

81 first ventilation pathway

82 second ventilation pathway

1. An air flow meter, comprising:
an enclosure including an auxiliary passage through which air to be measured flows and a circuit chamber partitioned from the auxiliary passage; and
a flow rate detection sensor including a diaphragm having a main surface on which a flow rate detection unit that detects a flow rate of the air flowing through the auxiliary passage is formed, a recessed section formed on a reverse-surface side of the diaphragm, and a package part having a first package section arranged in a state where the diaphragm is exposed and a second package section having an integrated structure with the first package section, in which the first package section is arranged in the auxiliary passage and the second package section is arranged in the circuit chamber; wherein
an airflow passage connected to the recessed section is formed in the interior of the package part, and
the recessed section communicates with the auxiliary passage via a plurality of ventilation pathways including at least a first ventilation pathway communicating with the auxiliary passage via the airflow passage and a second ventilation pathway communicating with the auxiliary passage through a pathway different from the first ventilation pathway via the airflow passage.

2. The air flow meter according to claim 1, wherein one end portion of the airflow passage is connected to the recessed section, and the other end portion of the airflow passage is connected to a branch portion where the first ventilation pathway and the second ventilation pathway branch from each other.

3. The air flow meter according to claim 2, wherein the branch portion is formed by a through hole.

4. The air flow meter according to claim 1, wherein a pressure sensor is disposed in the middle of the first ventilation pathway.

5. The air flow meter according to claim 1, further comprising a circuit board on which the flow rate detection sensor is mounted, wherein
the first ventilation pathway includes a ventilation part that ventilates the auxiliary passage and the circuit chamber at a position away from the second package section, and
the second ventilation pathway includes a ventilation gap formed between the package part and the circuit board.
